(19) United States
(12) Patent Application Publication
(10) Pub. No.: US 2012/0185336 A1
(43) Pub. Date: Jul. 19, 2012

(54) PERSONALIZED ATTRACTORS

(76) Inventor: Roy AHARONY, Tel Aviv (IL)

(21) Appl. No.: 13/008,038

(22) Filed: Jan. 18, 2011

(51) Int. Cl. G06Q 30/00

(52) U.S. Cl. 705/14.66

(57) ABSTRACT

To distribute advertisements to interested audiences, each of a plurality of users is enabled to create a respective personalized attractor. The personalized attractors are used to learn fields of interest of the users, and the advertisements are distributed according to the attractors' fields of interest. The system that does this includes: a storage medium for storing program code for enabling the users to create the personalized attractors, for using the personalized attractors to learn the fields of interest of the users and for distributing advertisements according to the learned fields of interest. The system also includes a processor for executing the program code, and network interfaces for receiving inputs from the users for creating said personalized attractors, for sending the advertisements to the users and for receiving the advertisements from advertisers.

### FIELD OF THE INVENTION

The invention relates generally to advertisement distribution, and more particularly to advertisement distribution using personalized animated characters called attractors.

### BACKGROUND OF THE INVENTION

The information age, also commonly known as the computer age or information era, is characterized by the ability of companies and individuals to transfer information and to have instant access to knowledge that would have been difficult or impossible to find previously. The information age has allowed rapid global communications and networking to shape modern society. The proliferation of the smaller and less expensive personal computers and improvements in computing power by the early 1980s resulted in a sudden access to and ability to share and store information for more and more companies and individuals.

The information age is also the information explosion age, and as the amount of information available grows immensely, questions like how reliable and accurate is all this information and how to navigate safely in the sea of too much information becomes very important and sometimes bothersome. For advertisers this question is inverted, how to distribute advertisements to interested audiences?

Search engines, desktop assistance, download managers, personalization desktop tools and desktop games are common tools in the information age. However, personalized animated characters created by users on their desktops where the personalized animated characters attract advertisements that are in their fields of interest (FOI), may answer the users and the advertisers questions described herein above, namely how to navigate safely in the sea of too much information and how to distribute advertisements effectively to interested audiences.

### SUMMARY OF THE INVENTION

Accordingly, it is a principal object of the present invention to provide an answer to at least some of the questions described hereinabove. This is provided in the present invention by a system configured for distributing advertisements to interested audiences and by a method for distributing advertisements to interested audiences, the method comprising the steps of (a) enabling each of a plurality of users to create a respective personalized attractor, (b) using said respective personalized attractors to learn fields of interest of said users, and (c) distributing the advertisements according to the users' fields of interest.

Furthermore, learning the fields of interest of the users is done by a learning scheme selected from the group of learning schemes consisting of data mining, machine learning, probability theory schemes, statistics schemes, pattern recognition and adaptive control schemes.

Furthermore, learning the fields of interest includes calculating a similarity measure and grouping together, in subgroups, the attractors whose similarity measure exceeds a pre-defined threshold, and wherein the users fields of interest are modified in accordance with the sub groups.

Furthermore, the created personalized attractors are autonomous virtual personalities that are used to learn the attractors' creators' fields of interest and hence learn to attract advertisements that are in their fields of interest.

Furthermore, the autonomous virtual personalities learn and distribute said advertisements independent to their users' creators being logged on or logged off to their computers.

According to embodiments of the present invention, a system configured for distributing advertisements to interested audiences is provided. The system comprising: (a) a storage medium for storing program code for: creating personalized attractors characters on users' computers' screens, using the respective personalized attractors to learn fields of interest of the users, and distributing advertisements according to the users' fields of interest. (b) a processor for executing said program code, (c) a first network interface configured for receiving, from users, inputs for creating the personalized attractors, and for sending the advertisements to the users, and (d) a second network interface for receiving the advertisements from advertisers.

Furthermore, the system storage medium is used to store data related to each created personalized attractor, to store advertisements to be distributed to the personalized attractors by the processor and to store a computer readable program code.

Furthermore, the stored computer-readable program code includes program code for enabling each of a plurality of users to create personalized attractor characters, for using the respective personalized attractors to learn fields of interest of the users, and for distributing advertisements according to the users' fields of interest.

Furthermore, the stored program code includes a program code for calculating a similarity measure and grouping together, in subgroups, the attractors whose similarity measure exceeds a pre-defined threshold, and wherein the attractors fields of interest are modified in accordance with the sub groups.

Furthermore, the stored program code manages the personalized attractors independent to their users' creators being logged on or logged off to their computers, wherein managing the personalized attractors may include learning and distributing advertisements according to the users learned field's of interest.

Additional features and advantages of the invention will become apparent from the following drawings and description.

### BRIEF DESCRIPTION OF THE DRAWINGS

For a better understanding of the invention and to show how the same may be carried into effect, reference will now be made, purely by way of example, to the accompanying drawings in which like numerals designate corresponding elements or sections throughout.

With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice. In the accompanying drawings:

FIG. 1 illustrates the personalized attractor animated characters system, according to embodiments of the present invention;

FIG. 2 illustrates the attractors downlink communication channels, according to embodiments of the present invention;

FIG. 3 illustrates the attractors uplink communication channels, according to embodiments of the present invention;

FIG. 4 illustrates the attractors data base architecture in a block diagram, according to embodiments of the present invention;

FIG. 5 illustrates the attractor's data structure, according to embodiments of the present invention;

FIG. 6 illustrates the advertisements data base, according to embodiments of the present invention;

FIG. 7 illustrates the attractor's data base cross table, according to embodiments of the present invention;

FIG. 8 illustrates the data mining advertisement distribution flow diagram, according to embodiments of the present invention;

FIG. 9 illustrates the data mining learning fields of interest flow diagram, according to embodiments of the present invention;

FIG. 10 illustrates the data mining learning fields of interest by elimination flow diagram, according to embodiments of the present invention;

FIG. 11 illustrates the data mining web advertisement distribution flow diagram, according to embodiments of the present invention;

FIG. 12 illustrates the data mining learning fields of interest from user searches flow diagram, according to embodiments of the present invention.

### DETAILED DESCRIPTION OF THE PREFERRED EMBODIMENTS

Embodiments of the present invention enable advertisers to distribute advertisements to interested audiences effectively using personalized animated characters created by users on their computer desktops called hereinafter personalized attractors or in short attractors.

The personalized attractor animated characters system allows the users to assign to his/her attractor a set of personal characteristics selected from a drop down list of personal characteristics and a set of behavior options selected from a drop down list of behavior options.

The personalized attractor animated characters system uses data mining to learn the fields of interest of the attractor's using characteristics inputs selected by the user, to find common fields of interest of sub group of similar attractors. The personalized attractor animated characters system uses the users responses to advertisement distribution for learning the fields of interest of the attractors. Hence the attractors' personalities, expressed in their learned fields of interest, evolve over time. According to embodiments of the present invention, advertisements are distributed to interested audiences effectively using these learned fields of interest of the personalized attractors.

The personalized attractor animated characters system uses a similarity measure to identify sub groups of similar attractors and to find their common fields of interest. The similarity measure is defined as an inner product of the attractor's selected characteristics, selected behavior options, and their responses to advertisement distribution.

The personalized attractor animated characters system aim is to answer the users and the advertisers questions presented herein above: how to navigate safely in the sea of too much information and how to distribute advertisements effectively to interested audiences.

Before explaining at least one embodiment of the invention in detail, it is to be understood that the invention is not limited in its application to the details of construction and the arrangement of the components set forth in the following description or illustrated in the drawings. The invention is applicable to other embodiments or of being practiced or carried out in various ways. Also, it is to be understood that the phraseology and terminology employed herein is for the purpose of description and should not be regarded as limiting.

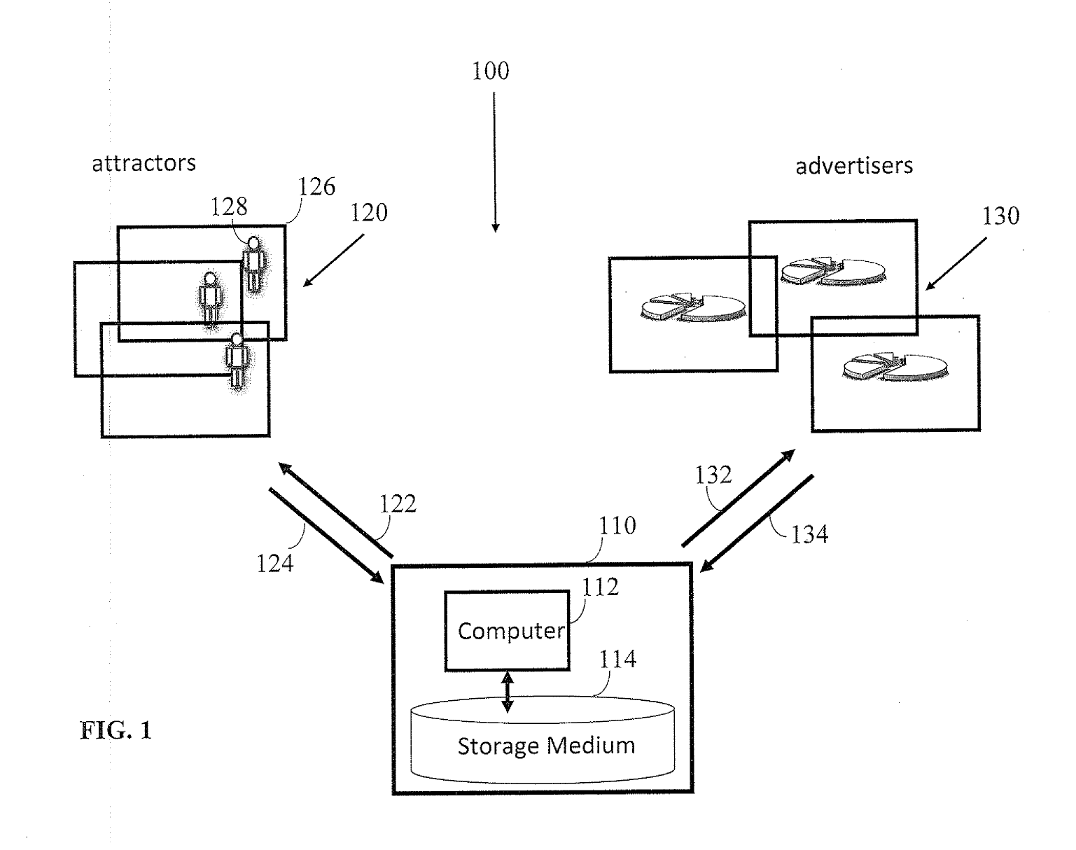

FIG. 1 illustrates the personalized attractor animated characters system, according to embodiments of the present invention. The personalized attractor animated characters system 100 is configured for distributing advertisements to interested audiences. The personalized attractor animated characters system 100 includes server 110 with a computer 112 and storage medium 114. Computer 112 includes further a processor (not shown) for executing program code stored in storage medium 114. Server 110 is connected to user's computers 120 through a network interface 122 and 124, configured for receiving, from users, various inputs and for sending to the users' data and control information. Server 110 is further connected to advertisers' computers 130 through a network interface 132 and 134, configured for receiving, from advertisers, advertisements and control information, and for sending to the advertisers information related to the personalized attractors system. The personalized attractor animated characters system 100 allows (a) creating personalized attractors animated characters 128 on users' desktops 126. (b) learning FOI's of the created personalized attractors, and (c) distributing advertisements to interested users according to the learned attractors' fields of interest.

Advertiser 130 may send advertisements to server 110 storage medium 114 and select a distribution type. Distribution types may include for example sending the advertisements to the interested attractors according to their learned FOI every day at a pre-defined time, sending e-mail notices with the advertisements attached to it or including links to the advertisements at the storage medium, sending text messages to users' cellular phones to inform them that they have a new advertisement in their mail box, etc.

The personalized attractor animated characters system program code is input to and compiled in server 110. The program code is stored in a non-transient computer-readable storage medium such as storage medium 114.

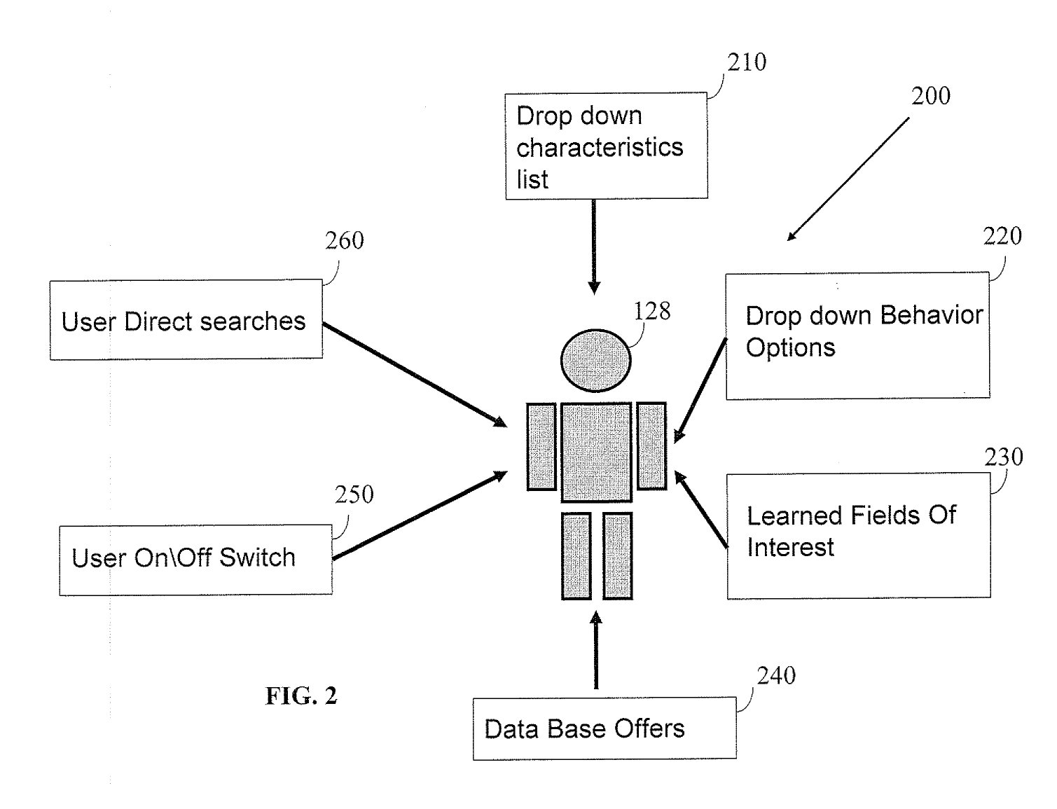

FIG. 2 illustrates the attractors downlink network channels, according to embodiments of the present invention. The input channels 200 to the attractor 128 originate from server 110 through network channel 122 (shown in FIG. 1) and from a user. The personalized attractor animated character 128 is created by users using the personalized attractor animated characters system 100. The personalized attractor animated characters system program code stored in storage medium 114 allows users to select the personalized attractor's characteristics from a dropdown characteristics list 210. The drop down characteristic list may include: gender, age, hair type and color, eye types and color, skin type and color, lips shape and color, nose shape and color, other body characteristics such as height, weight and movement styles. The selected characteristics of each attractor are stored in storage medium 114.

The user may further select behavior options from a dropdown list of behavior options 220. The drop down attractor behavior options list 220 may include: popup on user's computer screen options, communication preference (e-mail, text, downloads), attractor hobbies and favorites (music, sport, art, shopping, traveling, dancing, drinking, etc), etc. The selected attractor behavior options are stored in storage medium 114. According to embodiments of the present invention, the personalized attractors are autonomous virtual personalities managed by both the users and the personalized attractor animated characters system program code. As described further below, the attractors may pop up on the users' computer screens and offer and advertisement to the user for example and later disappear from the users' computer screen.

According to embodiments of the present invention, the attractors' behavior options list includes animated, human-like behaviors such as various facial expressions of human feelings, body language gestures and walking styles, etc. According to embodiments of the present invention, the attractors' animated characters may pop up and walk on the users' computer screen from right to left or from left to right and stop at the screen center or at another screen position selected by the user. The attractors may be configured to pop up with a dramatic visual effect, like an animated explosion accompanied with animated fire and smoke, on the computer screen, optionally accompanied by sound.

The attractors may be configured to disappear from the users' computer screen by walking out through the right side or through the left side of the screen, or by using another dramatic visual effect, like an animation movie that mimics the breaking of the computer screen after which the attractor walks inward and vanishes through the animated broken screen.

The attractors' appearance time on screen and the time between consequent reappearances are other behavior options that users may select from the behavior options list. According to embodiments of the present invention, users may allow the attractor to pop up onto the users' screen according to the fields of interest of the distributed advertisements. Accordingly, the users may configure their attractors to pop up when an advertisement in their fields of interest is distributed. The users may configure their attractors to pop up according to the attractors' software managed by server 110.

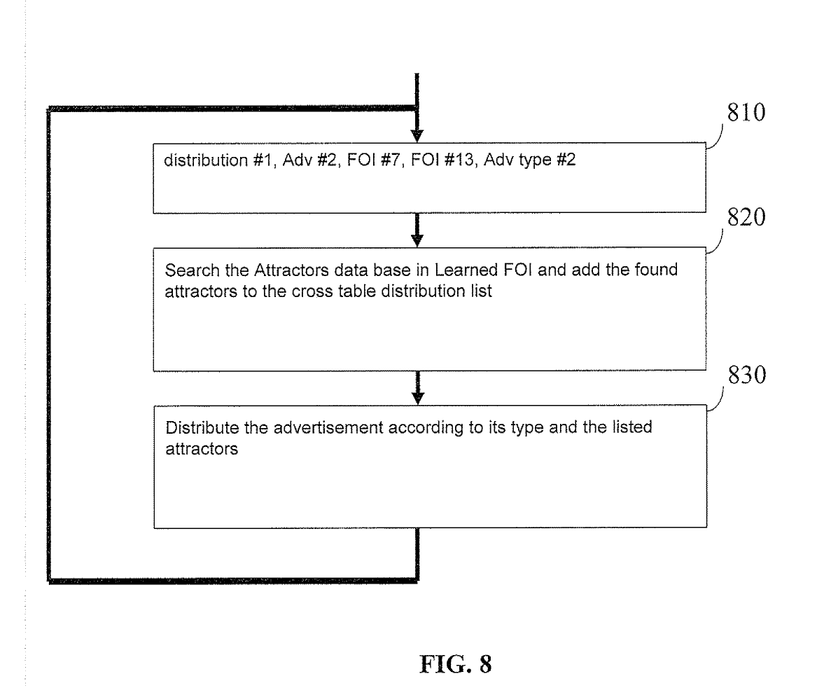

A learned FOI list 230 of each attractor is stored in storage medium 114. Data mining program learns the FOI of each attractor according to embodiments of the present invention. The data mining flows are described further below with reference to FIGS. 8-12. According to embodiments of the present invention, the personalized attractor animated character system may distribute advertisements 240 to the attractors according to their learned FOI. Hence, the attractors have a learned virtual personalities aimed to match the attractors' creators' fields of interest and to attract advertisements that are in their fields of interest. According to embodiments of the present invention, the attractors learn and distribute advertisements independent to their users' creators being logged on or logged off to their computers.

A user on/off software switch 250 may be used to turn the attractor off, disabling temporarily all activities of the attractor. Previous data related to the attractor, stored on the storage medium 114, remains as is, and no new data will be stored until the user will turn on the user on/off switch 250. According to embodiments of the present invention, the attractors may popup and disappear from the user's desktop according to a selection of a popup behavior option. However, even when the attractors disappear from the user's desktop, their activity continues according to the data mining program flows performed in server 110 by the computer 112 processor.

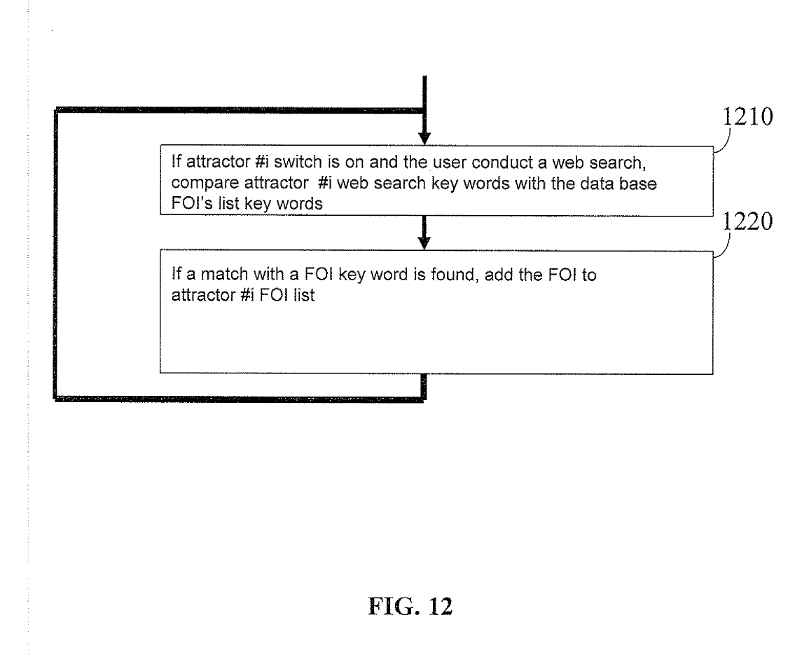

Users may conduct web searches 260 using available web search engines and if the user on/off software switch 250 is turned on, the data mining program will compare key words used by the user with the FOI's key words stored in the data base server and if a match is found will update the attractor FOI's list accordingly in storage medium 114 (see also FIG. 12 flow diagram).

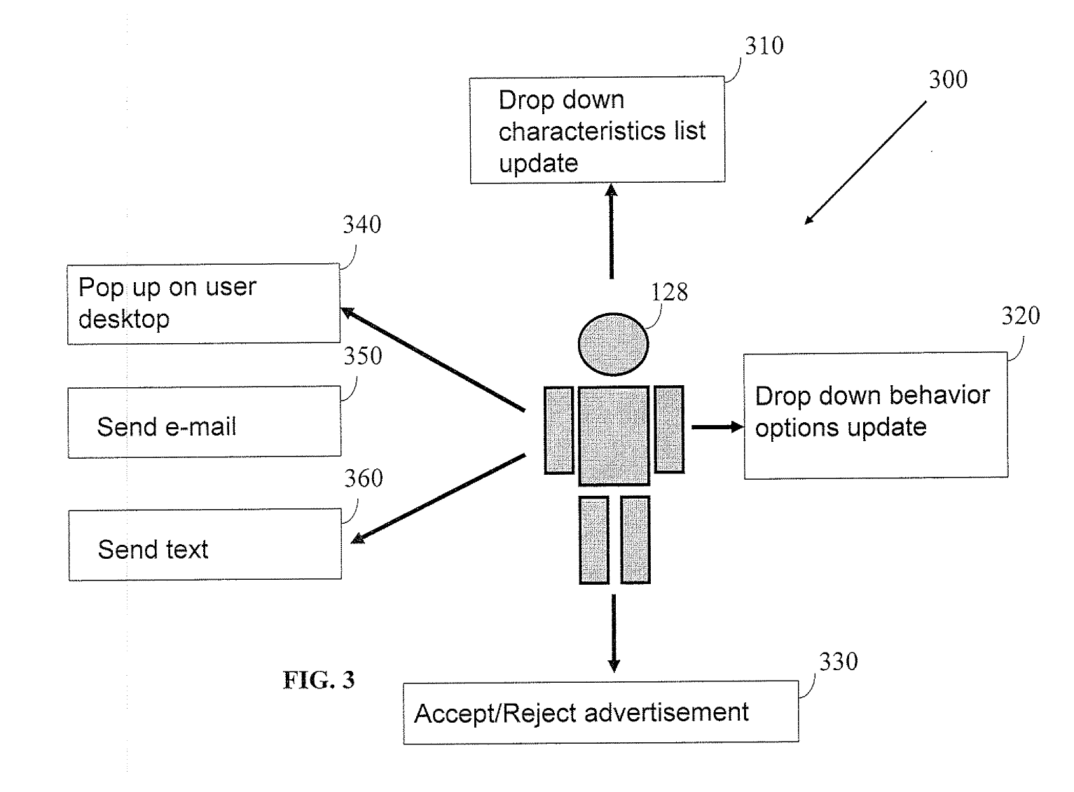

FIG. 3 illustrates the attractor's uplink communication channels, according to embodiments of the present invention. The output channels 300 of the attractor 128 reach server 110 and the users through network channel 124 (shown in FIG. 1). The users may update the characteristics of their attractors by modifying their selection of characteristics from the characteristics drop down list 310. The users may update the attractor's behavior options by modifying their selection of behavior options from the behavior options drop down list 320.

The user accepting or rejecting responses to advertisement distribution 330 are communicated by the attractors using the network interface 124 and stored in storage medium 114. The attractors may pop up on the users desktops 340, send e-mails 350 or text messages 360 to the users' cellular phones. Various options of popup behavior, of sending e-mails and/or text messages may be selected by the users from the drop down behavior options list 320.

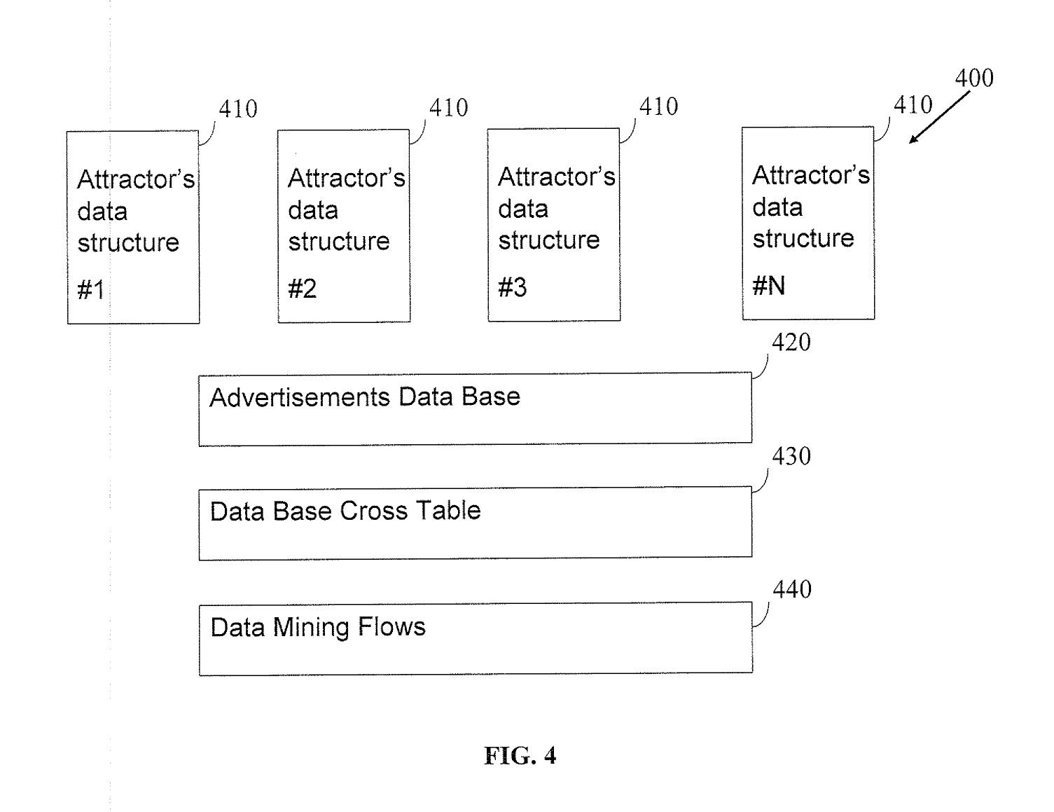

FIG. 4 illustrates the attractor's data base architecture in a block diagram, according to embodiments of the present invention. The attractor's data base includes the attractor's data structure 410 of each created attractor, attractor #1, attractor #2 till attractor #N, the advertisements data base 420, the data base cross table 430 and the data mining flows 440. The data base is stored in server 110 storage medium 114.

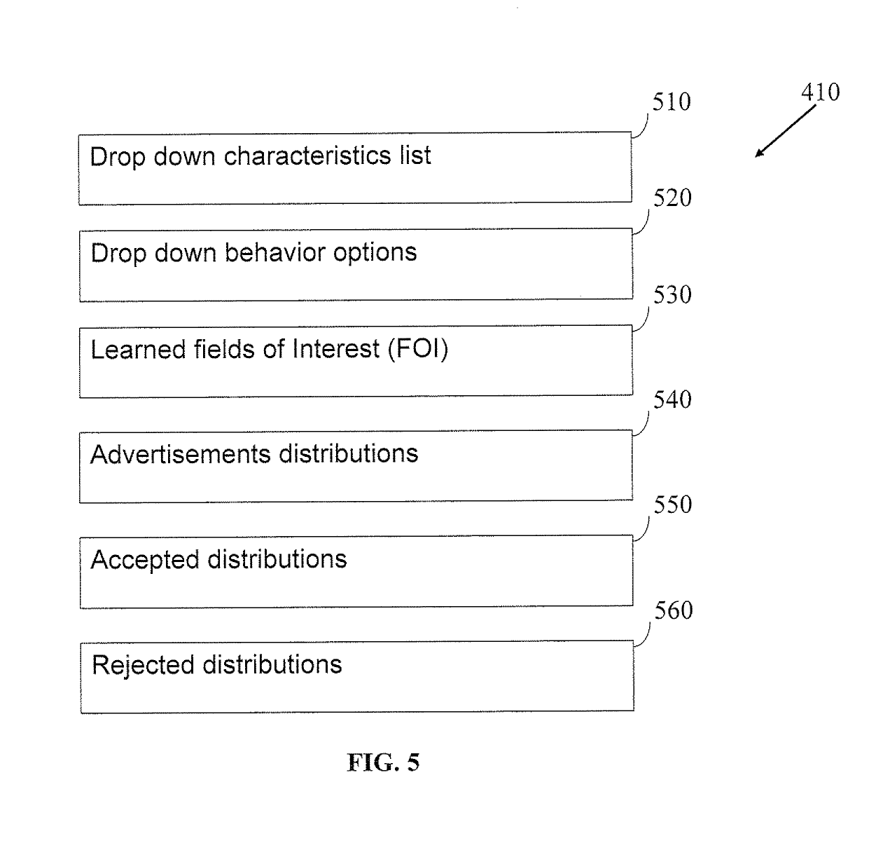

FIG. 5 illustrates the attractor's data structure, according to embodiments of the present invention. The attractor's data structure includes the drop down characteristics list 510, the drop down behavior options list 520, the learned FOI's list 530, the advertisement distribution 540, the accepted advertisements 550, and the rejected advertisements 560. The drop down characteristics and behavior options lists include all options offered to the user by the personalized attractor animated characters system 100. When a specific characteristic or behavior option is selected by a user a bit is set to 1 for this selection in the attractor's data structure 510 and 520. The learned FOI's list 530 are filled-in and updated by the data mining program flows described further below in FIGS. 8-12. The advertisement distributions 540 are filled-in by the personalized attractor animated characters system and include advertisements distributed to interested attractors. The accepted advertisements 550 and the rejected advertisements 560 are filled in according to the users responses to the advertisement distributions 540.

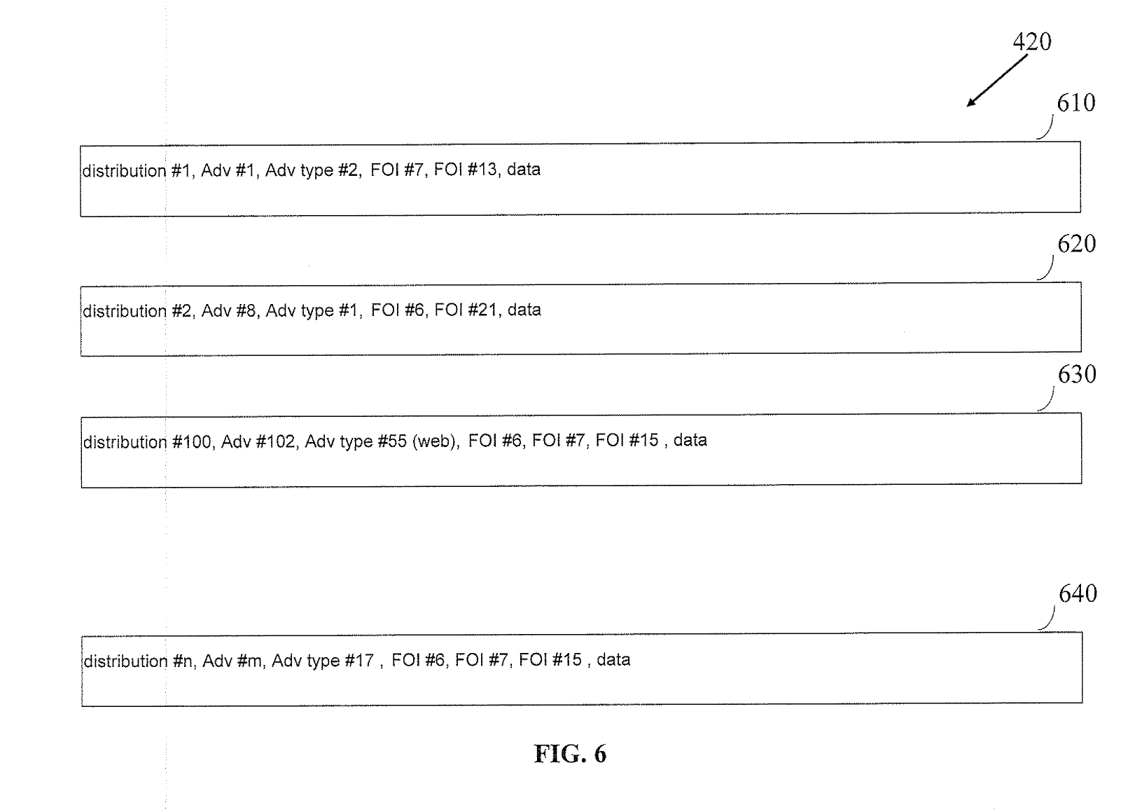

FIG. 6 illustrates the advertisements data base, according to embodiments of the present invention. The advertisement distributions 420 are filled in by the personalized attractor animated characters system 100, server 110, and particularly by computer's 112 processor according to the program code stored in storage medium 114. The advertisement distributions 420 include advertisements distributed to interested attractors by advertisers or advertisements that were found on the web. Each advertisement distribution starts with a header that includes the distribution number, the advertiser number, the advertisement type, the advertisement FOI's and finally the advertisement data (or a link to the advertisement data available on the web).

Advertisement distribution #1 610 header shows that this advertisement is distributed by advertiser #1, advertisement type #2, fields of interest defined by the advertiser are #7 and #13 for example and finally the advertisement data is attached. Advertisement distribution #100 630 header shows that this advertisement is distributed by advertiser #102 (chosen to code the personalized attractor animated characters system in this example), advertisement type is #55 (chosen to code a web search in contrast to an advertising agent), field of interest defined by the personalized attractor animated characters system for the web search are #6, #7 and #13 and finally the advertisement data is attached. FOI's #6, #7 and #13 could be, for example, John Lennon, music and rock & roll albums.

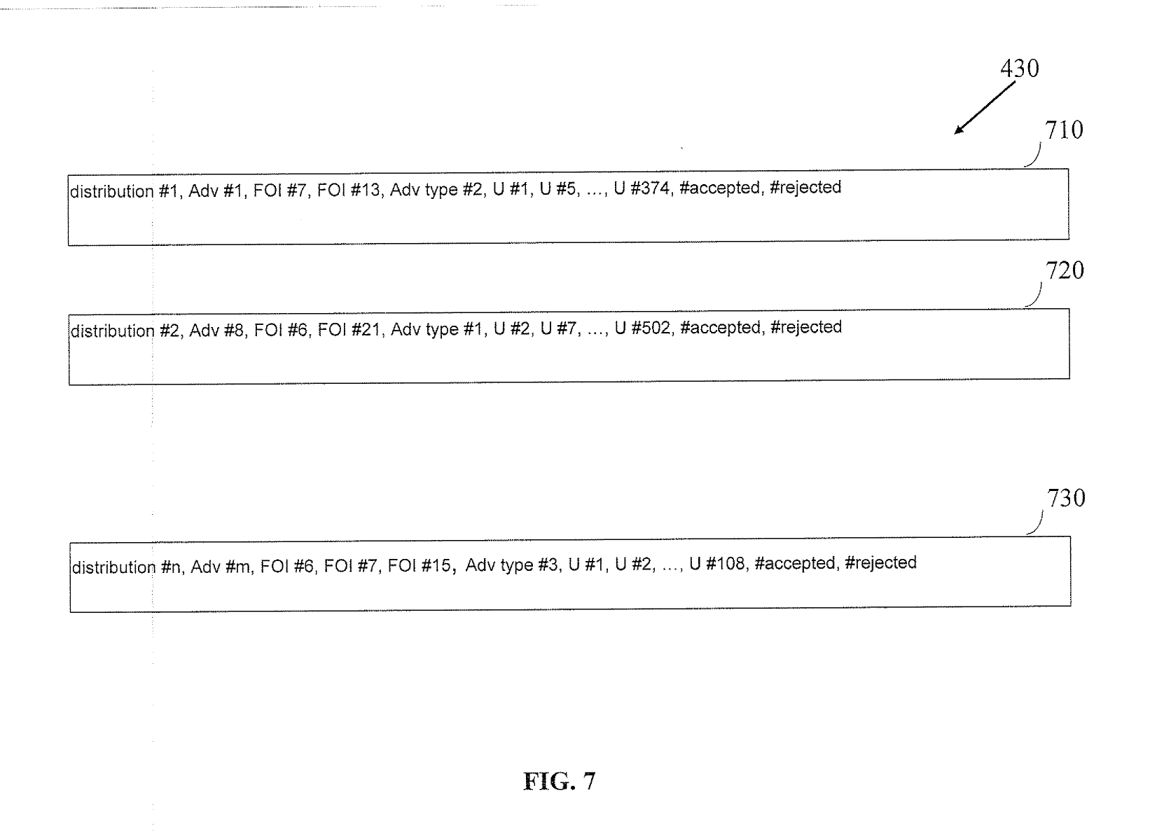

FIG. 7 illustrates the attractor's data base cross table, according to embodiments of the present invention. The cross table 430 includes all the advertisement distributed to the attractors by the personalized attractor animated characters system using server 110 processor and network interface 122 (shown in FIG. 1). The data mining program code, stored in storage medium 114 and executed by server's 110 processor, finds the attractors that may be interested in the advertisement according to their matching learned FOI's and add them to the cross table as U#1, U#5 and U#274 as shown in 710. The user accepts or rejects the advertisement and his response is stored in the data base cross table. The user responses are used by the data mining program to calculate the similarity measure, to find accordingly similar attractors sub group and to learn their common FOI's.

FIG. 8 illustrates the data mining advertisement distribution flow diagram, according to embodiments of the present invention. The distribution flow diagram illustrates that for each advertisement prepared for distribution 810, the data mining program searches 820 the attractors data base in the attractor's learned FOI list 530 and adds attractors with matching FOI's to the cross table distribution list. Next, the server's 110 processor distributes 830 the advertisement according to its type and the listed attractors using network interface 122.

According to certain embodiments of the present invention, a similarity inner product measure may be calculated in order to group similar attractors and to data mining common fields of interest of the similar attractors. The inner product may be calculated using the following binary vector defined for each attractor—

Vi=<drop down characteristic #1, drop down characteristic #2, . . . , drop down characteristic #n, drop down behavior #1, drop down behavior #2, . . . , drop down behavior #m, accepted adv #1, accepted adv #2, . . . , accepted adv #q, rejected adv #1, rejected adv #2, . . . , rejected adv #q| Eq. 1

Where ‘i’ is the index of the attractor and each binary value may be a 0 if reset and a 1 if set by the user via the network interface 124 or by the data mining program.
Next, the inner product of two attractors' vectors is calculated according to—

S_{i,j}=1/NORM<Vi|Vj> Eq. 2

Where NORM is the total number of elements that appear in the inner product and where the inner product is defined below—

<Vi|Vj>=Σ₁₌₁^{NORM} Vi¹*Vj Eq. 3

The inner product S_{i,j} is 1 if all elements of two attractors are the same and 0 if all the elements are different. Typically, S_{i,j} will be a fractional number, between zero and one, for most pairs of attractors that have partial similarity, meaning that only some elements of both attractors are the same. The similarity inner product measure may be used to define sub groups of similar attractors that have high similarity measure above a pre-defined threshold value.

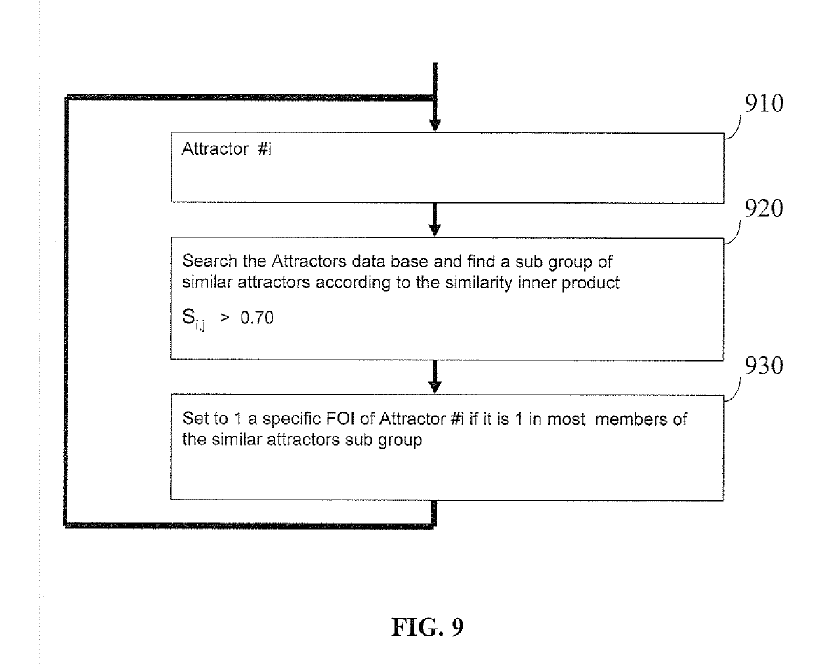

FIG. 9 illustrates the data mining learning fields of interest flow diagram, according to embodiments of the present invention. For each attractor 910 the data mining program calculates 920 the similarity inner product measure, S_{i,j}, between every two attractors, #i and #j, defined herein above and finds a sub group of similar attractors that have a high similarity measure above 0.7 for example. Next, the data mining program set to 1 a specific FOI of Attractor #i if it is 1 in most members of the similar attractors sub group 930.

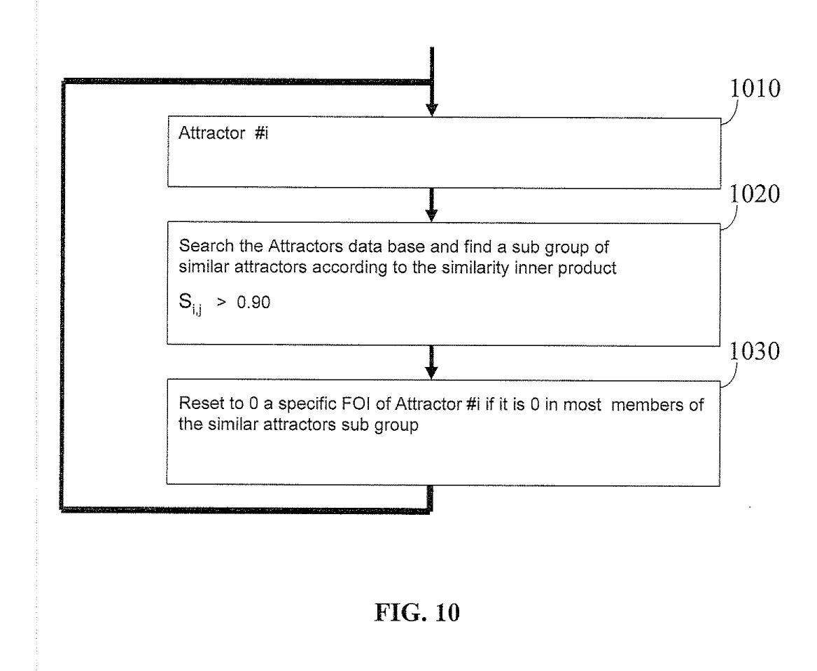

The data mining program may also reset to 0 the FOI of an attractor if most of the group members have 0 value for this FOI as shown in FIG. 10 1030. The similarity inner product described herein above is an example of how to define a similarity measure used by the data mining algorithm in certain embodiments of the present invention. Other similarity measures may be defined and are in the scope of the present invention. Furthermore, other learning schemes, such as, and not limited too, machine learning, probability theory schemes, statistics schemes, pattern recognition schemes and adaptive control schemes, may be used for learning the attractors fields of interest using the attractor animated characters system data base and may be included in embodiments of the present invention and are in the scope of the present invention.

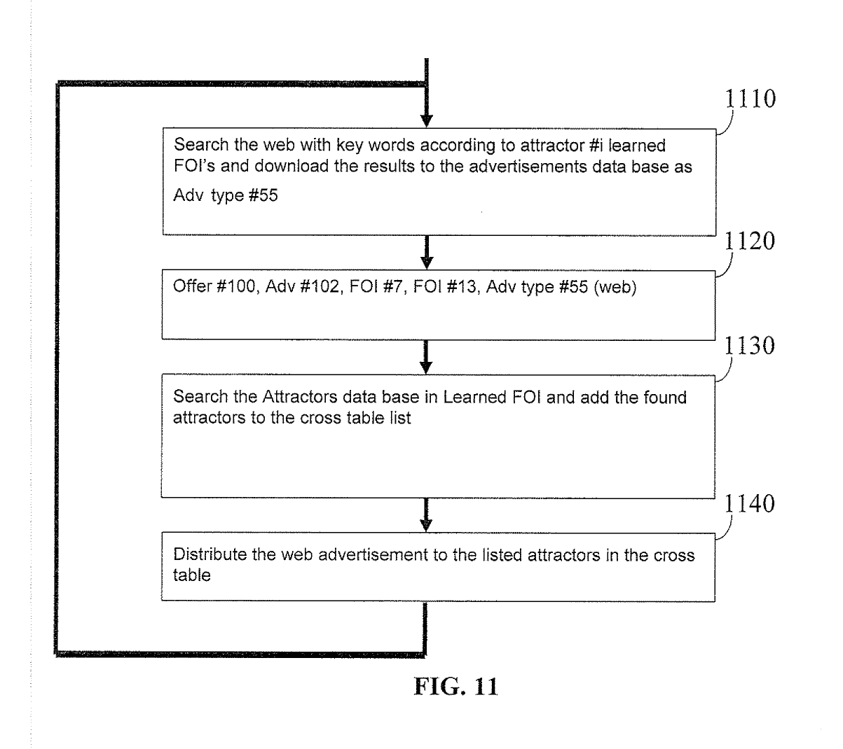

FIG. 11 illustrates the data mining web advertisement distribution flow diagram, according to embodiments of the present invention. The personalized attractor animated characters system may initiate a web search in order to find on the web available advertisements and to distribute them to the attractors according to their FOI's. The data mining program will initiate a search web 1110 with key words according to attractor #i learned FOI's and download the results to the advertisement data base as advertisement type #55 (selected to identify an advertisement found on the web). The found advertisement will be stored in the advertisement data base 420 with a header specifying the advertisement number, the searched FOI's and advertisement type #55 as shown in 1120. The data mining program will search the attractors data base and add attractors with matching FOI's to the data base cross table list 430. Finally, the server's 110 processor will distribute the web advertisement to the listed attractors 1140 using network interface 122.

FIG. 12 illustrates the data mining learning fields of interest from user searches flow diagram, according to embodiments of the present invention. The data mining program verifies that the attractor's on/off switch is turned on and if the user conducts a web search. If positive, the data mining program 1210 compares attractor #i web search key words with the data base FOI's list key words. If a match is found 1220 the data mining program set to 1 the appropriate attractor's learned FOI in the data base 530.

Advantageously, embodiments of the present invention enable advertisers to distribute advertisements to interested audiences effectively using personalized attractors.

Another advantage of the personalized attractor animated characters system described above is that a data mining program learns the fields of interest of the attractors continuously using characteristics inputs selected by the user, using common fields of interest of sub group of similar attractors and using the user's responses to advertisement distributions.

In summary, the personalized attractor animated characters system described above overcome the difficulties and limitations of the prior art advertisement distribution methods by the use of personalized attractors that learn the fields of interest of their creators and attract relevant advertisements to their users creators.

It is appreciated that certain features of the invention, which are, for clarity, described in the context of separate embodiments, may also be provided in combination in a single embodiment. Conversely, various features of the invention which are, for brevity, described in the context of a single embodiment, may also be provided separately or in any suitable sub-combination.

Unless otherwise defined, all technical and scientific terms used herein have the same meanings as are commonly understood by one of ordinary skill in the art to which this invention belongs. Although methods similar or equivalent to those described herein can be used in the practice or testing of the present invention, suitable methods are described herein.

All publications, patent applications, patents, and other references mentioned herein are incorporated by reference in their entirety. In case of conflict, the patent specification, including definitions, will prevail. In addition, the materials, methods, and examples are illustrative only and not intended to be limiting.

It will be appreciated by persons skilled in the art that the present invention is not limited to what has been particularly shown and described hereinabove. Rather the scope of the present invention is defined by the appended claims and includes both combinations and sub-combinations of the various features described hereinabove as well as variations and modifications thereof, which would occur to persons skilled in the art upon reading the foregoing description.

What is claimed is:

1. A method for distributing advertisements to interested audiences, the method comprising the steps of:
(a) enabling each of a plurality of users to create a respective personalized attractor;
(b) using said respective personalized attractors to learn fields of interest of said users; and
(c) distributing the advertisements according to said users' fields of interest.

2. The method according to claim 1, wherein said learning said fields of interest of said users is done by a learning scheme selected from the group of learning schemes consisting of data mining, machine learning, probability theory schemes, statistics schemes, pattern recognition and adaptive control schemes.

3. The method according to claim 2, wherein said learning said fields of interest includes calculating a similarity measure and grouping together, in subgroups, said attractors whose similarity measure exceeds a pre-defined threshold, and wherein said users fields of interest are modified in accordance with said sub groups.

4. The method according to claim 2, wherein said personalized attractors are autonomous virtual personalities that are used to learn the attractors' creators' fields of interest and hence learn to attract advertisements that are in their fields of interest.

5. The method according to claim 4, wherein said autonomous virtual personalities learn and distribute said advertisements independent to their users' creators being logged on or logged off to their computers.

6. A system configured for distributing advertisements to interested audiences, the system comprising:
(a) a storage medium for storing program code, wherein said program code includes program code for:
(i) creating personalized attractors characters on users' computers' screens;
(ii) using said respective personalized attractors to learn fields of interest of said users; and
(iii) distributing advertisements according to said users' fields of interest;
(b) a processor for executing said program code;
(c) a first network interface configured for receiving, from users, inputs for creating said personalized attractors, and for sending the advertisements to the users; and
(d) a second network interface for receiving the advertisements from advertisers.

7. The personalized attractors system according to claim 6, wherein said storage medium is used to store data related to each said created personalized attractor.

8. The personalized attractors system according to claim 6, wherein said storage medium is used to store advertisements to be distributed to said personalized attractors by said processor.

9. A non-transient computer-readable storage medium having computer readable code embodied on the computer-readable storage medium, the computer-readable code comprising:
(a) program code for enabling each of a plurality of users to create personalized attractor characters;
(b) program code for using said respective personalized attractors to learn fields of interest of said users; and
(c) program code for distributing advertisements according to said users' fields of interest.

10. The computer-readable storage medium according to claim 9, wherein said program code for learning fields of interest of said users using said created personalized attractors, includes a program code for calculating a similarity measure and grouping together, in subgroups, said attractors whose similarity measure exceeds a pre-defined threshold, and wherein said attractors fields of interest are modified in accordance with said sub groups.

11. The computer-readable storage medium according to claim 9, wherein said computer-readable code includes a program code that manage said personalized attractors independent to their users' creators being logged on or logged off to their computers.

12. The computer-readable storage medium according to claim 11, wherein said managing said personalized attractors independent to their users' creators being logged on or logged off to their computers includes said learning and said distributing advertisements according to the learned field's of interest.
